(19) United States
(12) Patent Application Publication
(10) Pub. No.: US 2026/0361364 A1
(43) Pub. Date: Nov. 12, 2026

(54) METHOD AND APPARATUS FOR SETTING PRIORITY OF THE CHANNEL STATE INFORMATION REPORT, AND COMMUNICATION SYSTEM

(71) Applicant: 1FINITY Inc., Kawasaki-shi (JP)

(72) Inventors: Gang SUN, Beijing (CN); Xin WANG, Beijing (CN)

(73) Assignee: 1FINITY Inc., Kawasaki-shi (JP)

(21) Appl. No.: 19/738,979

(22) Filed: Jul. 13, 2026

Related U.S. Application Data
(63) Continuation of application No. PCT/CN2024/073063, filed on Jan. 18, 2024.

(51) Int. Cl. H04B 7/06; H04B 17/318; H04W 24/10

(52) U.S. Cl. CPC H04B 7/0626; H04B 17/328; H04W 24/10

(57) ABSTRACT

An apparatus for setting a priority of a channel state information report, applied to a terminal equipment, includes: a receiver configured to receive configuration information of a channel state information report from a network device, wherein the configuration information comprises configuration of report quantity of channel state prediction for a first channel state information report; and first processor circuitry configured to calculate a value of a priority of the channel state information report according to the configuration information, and determine a priority of the channel state information report.

### CROSS-REFERENCE TO RELATED APPLICATION

This application is a continuation application under 35 U.S.C. 111 (a) of International Patent PCT/CN2024/073063 filed on Jan. 18, 2024, and designated the U.S., the entire contents of which are incorporated herein by reference.

### TECHNICAL FIELD

Embodiments of the present disclosure relate to the technical field of communications.

### BACKGROUND

As low-frequency band spectrum resources become scarce, a millimeter-wave frequency band is able to provide a greater bandwidth and becomes an important frequency band for 5G New Radio (NR) systems. Millimeter wave, due to a shorter wavelength, has propagation characteristics different from those of legacy low-frequency bands, such as a higher propagation loss, poor reflection and diffraction performance, etc. Therefore, a larger-scale antenna array will be usually adopted to form a shaped beam with greater gain, overcome propagation losses and ensure system coverage. 5G NR standard designs a series of schemes for beam management, such as beam sweeping, beam measurement, beam reporting, and beam indication, etc. However, when the number of transmitting and receiving beams is relatively large, load and latency of a system will be greatly increased.

It should be noted that the above introduction to the technical background is just to facilitate a clear and complete description of technical solutions of the present disclosure, and is elaborated to facilitate understanding of those skilled in the art. It cannot be considered that the technical solutions are known by those skilled in the art just because these solutions are elaborated in Background of the present disclosure.

### SUMMARY

With the development of Artificial Intelligence (AI) technology, applying the AI technology to wireless communication physical layers to solve difficulties of legacy methods has become one current technical direction. For beam management, using an AI model to predict a spatially optimal beam (pair) according to results of a small number of beam measurements is able to greatly reduce load and latency of a system.

In a legacy channel state information report (CSI report), one CSI report is associated with one priority value (i.e., a value of a CSI report priority), and different CSI reports are associated with different priority values, and the smaller a priority value is, the higher a priority is. When a terminal equipment needs to transmit a plurality of CSI reports to a network device simultaneously, the terminal equipment transmits the reports to the network device in ascending order of priority values.

When uplink resources are limited, a terminal equipment selects some CSI reports from a plurality of CSI reports to transmit to a network device. The terminal equipment makes a selection in ascending order of priority values, prioritizes transmission of CSI reports with higher priorities and omits CSI reports with lower priorities.

In addition, when a terminal equipment calculates CSI, if the terminal equipment needs to calculate a plurality of CSIs simultaneously to thereby generate CSI reports in a terminal side, and when calculation resources are limited, the terminal equipment preferentially calculates CSI with a high CSI report priority (i.e., a small priority value), that is, a terminal preferentially generates a CSI report with a high priority.

In a case where a network device configures parameters for a CSI report of a terminal equipment, the terminal equipment calculates priority values of different CSI reports according to the parameters configured by the network device.

Inventors of the present disclosure find that when performing spatial-domain or time-domain prediction on an analog beam (pair) via a terminal-side model, the terminal-side model needs to report a new report quantity to a network device. For the new report quantity, related arts have no relevant definition as for how to calculate a priority value of a CSI report and what kind of priority rule for a terminal to follow to transmit a new report quantity.

For at least one of the above problems or other similar problems, embodiments of the present disclosure provide a method and an apparatus for setting a priority of the channel state information report, and a communication system.

According to one aspect of embodiments of the present disclosure, an apparatus for setting a priority of the channel state information report is provided, applied to a terminal equipment, wherein the apparatus includes a first processing unit configured to control the terminal equipment to perform the following operations:
receiving a parameter related to a channel state information report (CSI), configured by a network device, wherein the channel state information report includes a first channel state information report related to an artificial intelligence (AI) model; and
calculating a value of the priority of the channel state information report according to the parameter, and determining a priority of the channel state information (CSI) report.

According to another aspect of embodiments of the present disclosure, an apparatus for setting a priority of the channel state information report is provided, applied to a network device, wherein the apparatus includes a second processing unit configured to control the network device to perform the following operations:
the network device configures a channel state information (CSI) report related parameter for a terminal equipment, wherein the channel state information report includes a first channel state information report related to an artificial intelligence (AI) model, and the parameter is used to calculate a value of a priority of the channel state information report; and
receives a channel state information (CSI) report transmitted by the terminal equipment.

One of advantageous effects of embodiments of the present disclosure lies in receiving a parameter of a first channel state information report related to an artificial intelligence model, and calculating a value of a priority of the first channel state information report according to the parameter, thereby being able to set a priority for a CSI report related to an AI model, thus avoiding uncertainty in behaviors of a terminal equipment when reporting a plurality of CSI reports.

Referring to later descriptions and drawings, specific implementations of the present disclosure are disclosed in detail, indicating modes in which principles of the present disclosure may be adopted. It should be understood that implementations of the present disclosure are not limited in scope thereby. Within spirits and scopes of terms of attached claims, implementations of the present disclosure include many changes, modifications, and equivalents.

Feature(s) described and/or shown for one implementation may be used in one or more other implementations in the same way or in a similar way, and may be combined with or replace feature(s) in other implementations.

It should be emphasized that term “include/contain” when being used herein refers to presence of a feature, a whole piece, a step, or a component, but does not exclude presence or addition of one or more other features, whole pieces, steps, or components.

### BRIEF DESCRIPTION OF DRAWINGS

Element(s) and feature(s) described in one drawing or one implementation of embodiments of the present disclosure may be combined with element(s) and feature(s) shown in one or more other drawings or implementations. In addition, in the drawings, similar reference signs denote corresponding components in several drawings, and may be used to indicate corresponding components used in more than one implementation.

FIG. 1 is a schematic diagram of a communication system in the present disclosure;

FIG. 2 is a schematic diagram of transmit beams and receive beams in a communication system in each embodiment of the present disclosure;

FIG. 3 is a schematic diagram of a method for setting a priority of the channel state information report in embodiments of a first aspect of the present disclosure;

FIG. 4 is a schematic diagram of a method for setting a priority of the channel state information report in embodiments of a second aspect of the present disclosure;

FIG. 5 is a schematic diagram of an apparatus for setting a priority of the channel state information report in embodiments of a third aspect;

FIG. 6 is a schematic diagram of an apparatus for setting a priority of the channel state information report in embodiments of a fourth aspect;

FIG. 7 is a schematic diagram of a terminal equipment in embodiments of a fifth aspect;

FIG. 8 is a schematic diagram of a network device in embodiments of a fifth aspect.

### DETAILED DESCRIPTION

Referring to the drawings, through the following Specification, the aforementioned and other features in the present disclosure will become obvious. The Specification and the drawings specifically disclose specific implementations of the present disclosure, indicating partial implementations in which principles of the present disclosure may be adopted. It should be understood that the present disclosure is not limited to described implementations, on the contrary, the present disclosure includes all modifications, variations and equivalents falling within scopes of attached claims.

In embodiments of the present disclosure, terms “first” and “second”, etc. are used to distinguish different elements in terms of appellation, but do not represent a spatial arrangement or time sequence, etc. of these elements, and these elements should not be limited by these terms. Term “and/or” includes any one of and all combinations of one or more of relevantly listed terms. Terms “contain”, “include” and “have”, etc. refer to presence of stated feature(s), element(s), component(s), or assembly/assemblies, but do not exclude presence or addition of one or more other features, elements, components, or assemblies.

In embodiments of the present disclosure, singular forms “a/an” and “the”, etc. include plural forms, and should be understood broadly as “a kind of” or “a type of”, but are not defined as the meaning of “one”, in addition, term “the” should be understood to include both singular forms and plural forms, unless a context clearly indicates otherwise. In addition, term “according to” should be understood as “at least partially according to . . . ”, and term “based on” should be understood as “at least partially based on . . . ”, unless a context clearly indicates otherwise.

In embodiments of the present disclosure, term “communication network” or “wireless communication network” may refer to a network that meets any of the following communication standards, such as New Radio (NR), Long Term Evolution (LTE), LTE-Advanced (LTE-A), Wideband Code Division Multiple Access (WCDMA), High-Speed Packet Access (HSPA) and so on.

And, communication between devices in a communication system may be performed according to a communication protocol of any stage, which e.g. may include but be not limited to the following communication protocols: 1G (generation), 2G, 2.5G, 2.75G, 3G, 4G, 4.5G, 5G, New Radio (NR) and so on, and/or other communication protocols that are currently known or will be developed in future.

In embodiments of the present disclosure, term “network device” e.g. refers to a device configured to access a terminal equipment to a communication network in a communication system and provide services for the terminal equipment. A network device may include but be not limited to the following devices: an Integrated Access and Backhaul node (IAB-node), a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB) and a 5G base station (gNB), etc., and may further include a Remote Radio Head (RRH), a Remote Radio Unit (RRU), a relay or a low power node (such as femeto, pico, etc.). And term “base station” may include some or all functions thereof, and each base station may provide communication coverage to a specific geographic region. Term “cell” may refer to a base station and/or a coverage area thereof, which depends on a context in which this term is used.

In embodiments of the present disclosure, term “User Equipment (UE)” or “Terminal Equipment (TE) or Terminal Device” refers to e.g., a device configured to access a communication network and receive network services via a network device. A terminal equipment may be fixed or mobile, and may also be called a Mobile Station (MS), a terminal, a Subscriber Station (SS), an Access Terminal (AT), a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under scenarios such as Internet of Things (IoT), the terminal equipment may further be a machine or an apparatus for performing monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, term “network side” or “network device side” refers to a side of a network, may be a certain base station, or may include one or more of the above network devices. Term “user side” or “terminal side” or “terminal equipment side” refers to a side of a user or terminal, may be a certain UE, or may include one or more of the above terminal equipments.

In the following descriptions, without causing confusion, terms “uplink control signal” and “Uplink Control Information (UCI)” or “Physical Uplink Control Channel (PUCCH)” are interchangeable, and terms “uplink data signal” and “uplink data information” or “Physical Uplink Shared Channel (PUSCH)” are interchangeable.

Terms “downlink control signal” and “Downlink Control Information (DCI)” or “Physical Downlink Control Channel (PDCCH)” are interchangeable, and terms “downlink data signal” and “downlink data information” or “Physical Downlink Shared Channel (PDSCH)” are interchangeable.

Moreover, transmitting or receiving a PUSCH may be understood as transmitting or receiving uplink data carried by a PUSCH, transmitting or receiving a PUCCH may be understood as transmitting or receiving uplink information carried by a PUCCH, transmitting or receiving a PRACH may be understood as transmitting or receiving a preamble carried by a PRACH; an uplink signal may include an uplink data signal and/or an uplink control signal, etc., or may also be called UL transmission or uplink information or an uplink channel. Transmitting an uplink transmission on an uplink resource may be understood as transmitting the uplink transmission by using the uplink resource. Similarly, downlink data/signal(s)/channel(s)/information may be understood correspondingly.

In embodiments of the present disclosure, higher-layer signaling may be e.g. radio resource control (RRC) signaling; for example, is called an RRC message, e.g. including an MIB, system information, and a dedicated RRC message; or is called an RRC information element (RRC IE). The higher-layer signaling may further be e.g. Medium Access Control (MAC) signaling; or is called a MAC control element (MAC CE). However, the present disclosure is not limited thereto.

Scenarios of embodiments of the present disclosure are described below through examples, however the present disclosure is not limited thereto.

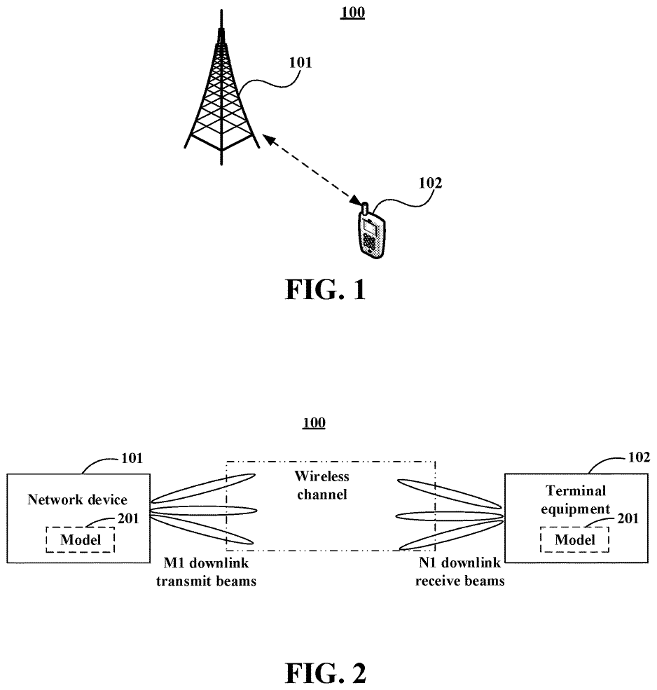

FIG. 1 is a schematic diagram of a communication system in the present disclosure, schematically describing a situation by taking a terminal equipment and a network device as an example, as shown in FIG. 1, a communication system 100 may include a network device 101 and a terminal equipment 102 (for the sake of simplicity, FIG. 1 makes description only by taking one terminal equipment as an example).

In embodiments of the present disclosure, existing services or future implementable services may be performed between the network device 101 and the terminal equipment 102. For example, these services include but are not limited to: enhanced Mobile Broadband (eMBB), massive Machine Type Communication (mMTC), Ultra-Reliable and Low-Latency Communication (URLLC) and so on.

The terminal equipment 102 may transmit data to the network device 101, for example using a grant-based or grant-free transmission mode. The network device 101 may receive data transmitted by one or more terminal equipments 102, and feed back information to terminal equipment(s) 102, such as acknowledgment ACK/non-acknowledgment ACK information, etc., and terminal equipment(s) 102 may acknowledge end of a transmission process, or may further perform new data transmission, or may perform data retransmission, according to feedback information.

In the following descriptions of the present disclosure, artificial intelligence (AI) may also be called artificial intelligence/machine learning (AI/ML), these two nouns may be interchangeable.

In each of the following embodiments of the present disclosure, signaling transmitted by a network device to a terminal equipment may be transmitted via downlink control information (DCI), and/or a medium access control control element (MAC CE), and/or radio resource control (RRC) signaling.

In each embodiment of the present disclosure, reporting may refer to an action in which a terminal equipment transmits information to a network device. For example, that a terminal equipment reports a CSI report may refer to that a terminal equipment transmits a CSI report to a network device.

In each embodiment of the present disclosure, a channel state information report may also be denoted as CSI report.

In each embodiment of the present disclosure, a first channel state information report may also be called: a channel state information report related to an artificial intelligence (AI) model, or a channel state information report carrying a report quantity related to an artificial intelligence (AI) model.

In each embodiment of the present disclosure, an AI model includes but is not limited to: an input layer, a plurality of convolutional layers, a concatenation layer (concat), a fully connected layer (FC), and a quantizer, etc. Processing results of the plurality of convolutional layers are merged in the concatenation layer. For a specific structure of an AI model, related arts may be referred to, and detailed description thereof is omitted here.

FIG. 2 is a schematic diagram of transmit beams and receive beams in a communication system in each embodiment of the present disclosure. As shown in FIG. 2, in a communication system 100, by taking a downlink channel as an example, a network device 101 may have M1 downlink transmit beams DL TX, and a terminal equipment 102 may have N1 downlink receive beams DL RX.

In embodiments of the present disclosure, as shown in FIG. 2, a model 201 for predicting a beam measurement result may be deployed in the network device 101 or the terminal equipment 102. The model 201 may predict measurement results of M1*N1 beams according to measurement results of partial beams. The model 201 e.g. may be an AI model.

In addition, for uplink channels, the network device 101 may have N2 uplink receive beams (not shown in FIG. 2), and the terminal equipment 102 may have M2 uplink transmit beams UL TX (not shown in FIG. 2).

Descriptions are made below with reference to drawings and embodiments.

### Embodiments of a First Aspect

For legacy channel state information reports (CSI reports), after a network device configures a parameter for reporting of a terminal equipment, the terminal equipment calculates a priority value Pri_{CSI} of different CSI reports according to a configuration of the network device. The priority value Pri_{CSI} may be obtained by calculation according to the following parameters: a CSI report configuration identifier, a serving cell index, a CSI report quantity, and a CSI report configuration type.

For example, the priority value Pri_{CSI} may be calculated using the following equation (1):

Pri_{CSI}(y,k,c,s)=2·N_{cells}·Mₛ·y+N_{cells}·M·k+Mₛ·c+s (1)

In equation (1), y denotes a CSI report configuration type. For an aperiodic CSI report carried by a Physical Uplink Shared Channel (PUSCH), y=0; for a semi-persistent CSI report carried by a PUSCH, y=1; for a semi-persistent CSI report carried by a Physical Uplink Control Channel (PUCCH), y=2; and for a periodic CSI report carried by a PUCCH, y=3.

k is a parameter representing a CSI report quantity. For a CSI report carrying Reference Signal Receiving Power (L1-RSRP) or Signal to Interference plus Noise Ratio (L1-SINR), k=0; for a CSI report not carrying L1-RSRP or L1-SINR, k=1.

c is a parameter representing a serving cell index. Ncells is a parameter maxNrofSrevingCells configured by a higher layer, i.e., a maximum number of serving cells.

s is a parameter representing a CSI report configuration identifier (reportConfigID), and Ms is a parameter maxNrofCSI-ReportConfigurations configured by a higher layer, i.e., a maximum number of CSI report configurations.

When performing spatial-domain or time-domain prediction on an analog beam (pair) by using an AI model at a terminal equipment side, during a model inference stage, a terminal equipment reports an output of the model to a network device, a reported content thereof may be predicted L1-RSRP/L1-SINR or predicted probability information (for example, the probability information is a probability that a certain beam is an optimal beam), predicted reference signal resource indicator (CRI/SSB-RI), the reference signal resource indicator being a Channel State Information Reference Signal Resource Indicator (CRI) or a Synchronization Signal Block Resource Indicator (SSB-RI). During a model monitoring stage, if a performance metric value of a model is calculated at a terminal side, the terminal also needs to report the performance metric value of the model to a network device. A performance metric value of a model may be prediction accuracy of a beam, an estimation error of L1-RSRP/L1-SINR, a throughput, or a Block Error Rate (BLER), etc.

When performing spatial-domain or time-domain prediction on an analog beam (pair) via an AI model at a terminal equipment side, a terminal equipment reports a new report quantity to a network device. For the new report quantity, how to calculate a priority value of a CSI report and what kind of priority rule for a terminal equipment to follow to transmit a new report quantity are problems that need to be solved.

In order to solve the above problems, embodiments of a first aspect of the present disclosure provide a method for setting a priority of the channel state information report, the method being applied to a terminal equipment, such as a terminal equipment 102 in FIG. 1.

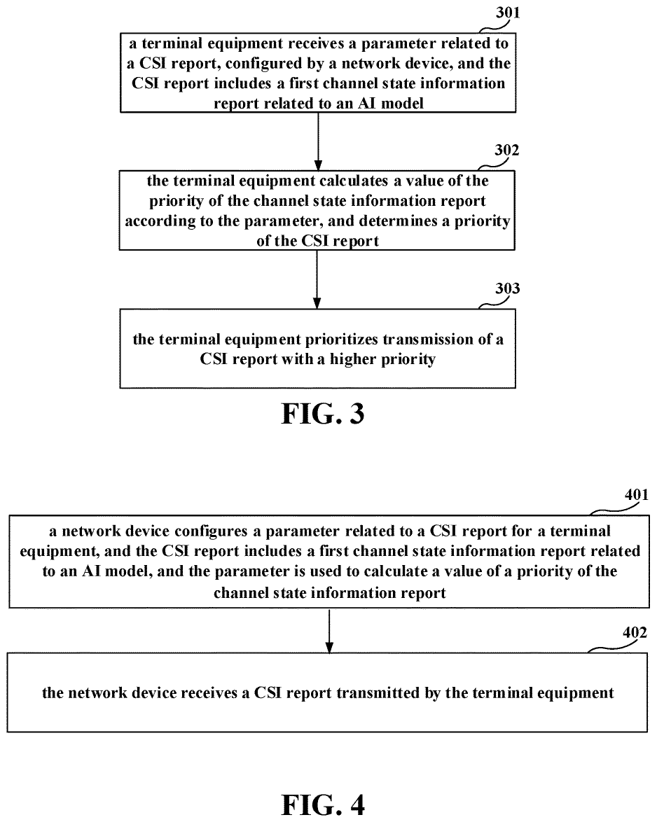

FIG. 3 is a schematic diagram of a method for setting a priority of the channel state information report in embodiments of a first aspect. As shown in FIG. 3, the method for setting a priority of the channel state information report includes:
operation 301, a terminal equipment receives a parameter related to a channel state information (CSI) report, configured by a network device, and the channel state information report includes a first channel state information report related to an artificial intelligence (AI) model; and
operation 302, the terminal equipment calculates a value of the priority of the channel state information report according to the parameter, and determines a priority of the channel state information (CSI) report.

According to embodiments of the first aspect, a terminal equipment receives a parameter of a first channel state information report related to an artificial intelligence (AI) model, and calculates a value of a priority of the first channel state information report according to the parameter, thereby being able to set a priority for a CSI report related to an AI model, thus avoiding uncertainty in behaviors of a terminal equipment when reporting a plurality of CSI reports.

In the present disclosure, a value of a channel state information report (CSI report) priority may also be called a priority value of a channel state information report (CSI report), and the smaller a value of a CSI report priority is, the higher a priority of a CSI report is.

As shown in FIG. 3, the method for setting a priority of the channel state information report may further include:
operation 303, the terminal equipment prioritizes transmission of a channel state information (CSI) report with a higher priority.

In operation 303, a terminal equipment may transmit CSI reports in descending order of priorities.

For example, when uplink resources are limited, a terminal equipment selects some CSI reports from a plurality of CSI reports to transmit to a network device. The terminal equipment makes a selection in ascending order of priority values, prioritizes transmission of CSI reports with higher priorities and omits CSI reports with lower priorities.

In addition, when a terminal equipment computing CSI, if the terminal equipment needs to compute a plurality of CSIs simultaneously to thereby generate CSI reports in a terminal side, and when computing resources are limited, the terminal equipment preferentially computes CSI with a high CSI report priority (i.e., a small priority value), that is, a terminal preferentially generates a CSI report with a high priority.

In some embodiments of the present disclosure, a channel state information report (CSI report) quantity related to an AI model may include predicted Layer 1 reference signal receiving power (L1-RSRP) or a Layer 1 signal to interference plus noise ratio (L1-SINR), probability information of beam prediction, or performance metrics of a model.

The predicted Layer 1 reference signal receiving power (L1-RSRP) or the Layer 1 signal to interference plus noise ratio (L1-SINR), or the probability information of beam prediction may be obtained by a terminal equipment through inferring of an artificial intelligence (AI) model, and may be called a report quantity related to model inference, and a performance metric value of the model may be obtained by a terminal equipment through performance monitoring of an artificial intelligence model (AI), and may be called a report quantity related to model performance monitoring.

In at least some embodiments, a terminal equipment may expect that a first channel state information report carrying a report quantity related to model inference and a first channel state information report carrying a report quantity related to model performance monitoring are not transmitted simultaneously.

In the present disclosure, the channel state information (CSI) report in operation 301 further includes a second channel state information report that is not related to an artificial intelligence (AI) model.

In at least some embodiments, a terminal equipment may expect that a first channel state information report and a second channel state information report are not transmitted simultaneously.

In at least some other embodiments, in a case where a first channel state information report and a second channel state information report are transmitted simultaneously: a terminal equipment expects that a value of a priority of the first channel state information report is greater than a value of a priority of the second channel state information report, or, a terminal equipment expects that a value of a priority of the second channel state information report is greater than a value of a priority of the first channel state information report.

In the present disclosure, that two or more channel state information reports are transmitted simultaneously may refer to that a terminal equipment transmits the two or more channel state information reports on the same time resource. That two or more channel state information reports are not transmitted simultaneously may refer to that time resources used by a terminal equipment to transmit the two or more channel state information reports are different from each other.

In at least some embodiments of operation 302, a parameter for calculating a value of a priority of the channel state information report may include at least one of the following parameters:
a parameter s representing a channel state information (CSI) report configuration identifier;
a parameter c representing a serving cell index;
a parameter k representing a channel state information report quantity (CSI report quantity);
a parameter y representing a channel state information report configuration type (CSI report configuration type); or
a parameter x representing whether a channel state information report is related to an artificial intelligence (AI) model.

The parameter x representing whether a channel state information report is related to an artificial intelligence (AI) model may be used to indicate whether the channel state information report contains a channel state information (CSI) report quantity related to an artificial intelligence (AI) model. For example, when the parameter x takes one value, it may indicate that the channel state information (CSI) report contains a channel state information (CSI) report quantity related to an artificial intelligence (AI) model. That is, the CSI report is related to an artificial intelligence (AI) model, i.e., the CSI report is a first CSI report. When the parameter x takes another value, it may indicate that the CSI report does not contain a channel state information (CSI) report quantity related to an artificial intelligence (AI) model. That is, the CSI report is not related to an artificial intelligence (AI) model, i.e., the CSI report is a second CSI report.

For calculation of a value of a priority of the second channel state information report that is not related to an artificial intelligence (AI) model, values of the parameter k representing a channel state information report quantity may be a first set, i.e., the value of the parameter k may be a first value (e.g., k=0) or a second value (e.g., k=1).

In some embodiments, for calculation of a value of a priority of the first channel state information report, a set of values of the parameter k representing a channel state information report quantity may be the same as the first set.

For example, for calculation of a value of a priority of the first channel state information report, the value of the parameter k representing a channel state information report quantity is a first value (e.g., k=0) or a second value (e.g., k=1).

For another example, for calculation of a value of a priority of the first channel state information report carrying a report quantity related to artificial intelligence (AI) model inference, the value of the parameter k representing a channel state information report quantity is one of a first value (e.g., 0) and a second value (e.g., 1), and for calculation of a value of the priority of the first channel state information report carrying a report quantity related to artificial intelligence (AI) model performance monitoring, the value of the parameter k representing a channel state information report quantity is the other of a first value and a second value. In one example, for calculation of a value of a priority of the first channel state information report carrying a report quantity related to artificial intelligence (AI) model inference, the value of the parameter k representing a channel state information report quantity is 0, and for calculation of a value of a priority of the first channel state information report carrying a report quantity related to artificial intelligence (AI) model performance monitoring, the value of the parameter k representing a channel state information report quantity is 1; vice versa.

For another example, for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, values of the parameters k representing a channel state information (CSI) report quantity are a first value or a second value, and a terminal equipment expects that at least one of a channel state information (CSI) report configuration identifier, a serving cell index or a channel state information report configuration type configured by a network device is not the same.

In some embodiments, for calculation of a value of a priority of the first channel state information report, a set of values of the parameter k representing a channel state information report quantity may be different from the first set.

For example, for calculation of a value of a priority of the first channel state information report, a value of the parameter k representing a channel state information report quantity may be different from a first value and a second value.

In some examples, for calculation of a value of a priority of the first channel state information report carrying a report quantity related to artificial intelligence (AI) model inference, the value of the parameter k representing a channel state information report quantity is a third value, and for calculation of a value of the priority of the first channel state information report carrying a report quantity related to artificial intelligence (AI) model performance monitoring, the value of the parameter k representing a channel state information report quantity is a fourth value. The third value and the fourth value may be equal or unequal.

In some implementations, a third value is equal to a fourth value. For calculation of a value of a priority of the first channel state information report carrying a report quantity related to artificial intelligence (AI) model inference, and for calculation of a value of a priority of the first channel state information report carrying a report quantity related to artificial intelligence (AI) model performance monitoring, a terminal equipment expects that at least one of a channel state information (CSI) report configuration identifier, a serving cell index or a channel state information report configuration type configured by a network device is not the same, thereby distinguishing a priority of the first channel state information report carrying a report quantity related to artificial intelligence (AI) model inference and a priority of the first channel state information report carrying a report quantity related to artificial intelligence (AI) model performance monitoring via at least one of a channel state information (CSI) report configuration identifier, a serving cell index or a channel state information report configuration type.

In some embodiments, a value of a priority of the channel state information report may be calculated according to a parameter x representing whether a channel state information report is related to an artificial intelligence (AI) model.

For example:
for calculation of a value of a priority of the first channel state information report, a value of the parameter x representing whether a channel state information report is related to an artificial intelligence (AI) model is one of a fifth value and a sixth value; for calculation of a value of a priority of the second channel state information report that is not related to an artificial intelligence (AI) model, a value of the parameter x representing whether a channel state information report is related to an artificial intelligence model is the other of the fifth value and the sixth value. The fifth value e.g., is 0, and the sixth value e.g., is 1.

When specifically calculating a value of a priority of the channel state information report, a weight of at least one of a parameter s representing a channel state information (CSI) report configuration identifier, a parameter c representing a serving cell index, a parameter k representing a channel state information (CSI) report quantity or a parameter y representing a channel state information (CSI) report configuration type is adjusted by using a parameter x representing whether a channel state information report is related to an artificial intelligence model (AI).

In the following text, embodiments of the first aspect of the present disclosure will be described in detail with reference to specific embodiments.

### Embodiment 1

In legacy channel state information reporting, a network device configures one or more reports needing to be transmitted by the network device, and corresponding parameters for a terminal via RRC signaling, for example configures one or more reports needing to be transmitted for a terminal in a CSI-MeasConfig information element, as shown in the following Table 1.

TABLE 1

| | |
|---|---|
| CSI-MeasConfig ::= | SEQUENCE { |

...

| | |
|---|---|
| csi-ReportConfigToAddModList | SEQUENCE (SIZE (1..maxNrofCSI- |
| ReportConfigurations)) OF CSI-ReportConfig | OPTIONAL, |
| csi-ReportConfigToReleaseList | SEQUENCE (SIZE (1..maxNrofCSI- |

```
ReportConfigurations)) OF CSI-ReportConfigId OPTIONAL,
  ...
  }
```

Specific parameters of each report are given in the CSI-reportConfig information element, as shown in Table 2.

TABLE 2

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |

```
    ...
  },
```

| | |
|---|---|
| reportQuantity | CHOICE { |

```
    ...
  },
  ...
}
```

Parameters include a CSI report configuration identifier (ID), a serving cell index, a CSI report quantity, and a CSI report configuration type (periodic, semi-persistent, aperiodic). In addition, for different CSI report configuration types, time-frequency resources required for transmitting CSI reports are further configured.

According to a configuration, a terminal equipment transmits one or more CSI reports to a network device, and calculates a value of a priority for each report (refer to Formula (1) for a specific method), and the smaller a value of a priority is, the higher a priority is. When a terminal equipment needs to transmit a plurality of CSI reports on the same time resource, if resources are limited, the terminal equipment prioritizes transmission of a CSI report with a higher priority according to a value of a calculated priority, and omits CSI reports with lower priorities.

When performing spatial-domain or time-domain prediction on an analog beam (pair) by using a terminal-side AI model, during a model inference stage, a terminal equipment needs to report an output of the model to a network device, a reported content thereof may be predicted L1-RSRP/L1-SINR or probability information of beam prediction (e.g., a probability that a certain predicted beam is an optimal beam), predicted reference signal resource indicator (CRI/SSB-RI). During a model monitoring stage, if a performance metric value of a model is calculated at a terminal side, the terminal equipment also needs to report the performance metric value of the model to a network device.

The performance metric value of the model may be prediction accuracy of a beam, an estimation error of L1-RSRP/L1-SINR, or a throughput//BLER, etc. That is, when performing spatial-domain or time-domain prediction on an analog beam (pair) by using a terminal-side AI model, a terminal equipment will generate a new report quantity, and the terminal equipment needs to calculate a value of a priority for a CSI report carrying the new report quantity, and transmits the CSI report carrying the new report quantity according to a predefined priority rule.

When a network device expects a terminal equipment to transmit a report related to an AI model, the network device needs to specify, in a configuration of report parameters, a report quantity contained in the report. For example, in the reportQuantity information field of the CSI-reportConfig information element shown in Table 2, a report quantity related to an AI model is added. The report quantity includes a report quantity related to AI model inference, such as predicted L1-RSRP/L1-SINR, predicted reference signal resource indicator (CRI/SSB-RI), or probability information of beam prediction and a reference signal resource indicator. The report quantity may further include a report quantity related to AI model performance monitoring, such as a performance metric value of an AI model (accuracy of beam prediction, an estimation error of L1-RSRP/L1-SINR, a throughput, a frame error rate, etc.).

When a terminal equipment needs to transmit a plurality of CSI reports simultaneously, the terminal equipment prioritizes transmission of a CSI report with a higher priority. When resources are limited, the terminal equipment omits transmission of CSI reports with lower priorities.

In some embodiments, if a network device does not expect that a CSI report related to an AI model is omitted, the network device may, through a scheduling algorithm thereof, ensure that a CSI report related to an AI model and a CSI report not related to an AI model are not transmitted simultaneously, that is, a terminal equipment expects that a CSI report related to an AI model (i.e., a first CSI report) and a CSI report not related to an AI model (i.e., a second CSI report) are not transmitted simultaneously.

In some embodiments, if a network device does not expect that a CSI report related to AI model inference is omitted, the network device may, through a scheduling algorithm thereof, ensure that a CSI report related to AI model inference and a CSI report not related to AI model inference are not transmitted simultaneously, that is, a terminal equipment expects that a CSI report related to AI model inference (i.e., a first CSI report carrying a report quantity related to model inference) and a CSI report not related to AI model inference (i.e., a first CSI report and/or a second CSI report carrying a report quantity related to model performance monitoring) are not transmitted simultaneously.

In some embodiments, if a network device does not expect that a CSI report related to AI model performance monitoring is omitted, the network device may, through a scheduling algorithm thereof, ensure that a CSI report related to AI model performance monitoring and a CSI report not related to AI model performance monitoring are not transmitted simultaneously, that is, a terminal equipment expects that a CSI report related to AI model performance monitoring (i.e., a first CSI report carrying a report quantity related to model performance monitoring) and a CSI report not related to AI model performance monitoring (i.e., a first CSI report and/or a second CSI report carrying a report quantity related to model inference) are not transmitted simultaneously.

### Embodiment 2

When performing spatial-domain or time-domain prediction on an analog beam (or pair) via a terminal-side AI model, for a CSI report related to an AI model (i.e., a first CSI report) and a CSI report not related to an AI model (i.e., a second CSI report), values of priorities of these CSI reports may be calculated according to at least one of the following parameters:
a parameter s representing a channel state information (CSI) report configuration identifier;
a parameter c representing a serving cell index;
a parameter k representing a channel state information report quantity (CSI report quantity); or
a parameter y representing a channel state information report configuration type (CSI report configuration type).

For a legacy CSI report (i.e., a CSI report not related to an AI model), when calculating a value of a priority thereof, a CSI report quantity is divided into two categories: a first category being L1-RSRP or L1-SINR; and a second category being non-L1-RSRP or L1-SINR, such as a channel quality indicator (CQI), a rank indicator (RI), a precoding matrix indicator (PMI), etc.

When calculating a value of a CSI report priority related to an AI model, in some embodiments, a new report quantity (e.g., a new report quantity related to model inference is predicted L1-RSRP/L1-SINR or probability information of beam prediction, etc.; and a report quantity related to model monitoring is a performance metric value, etc.) may be categorized as a first category. That is, when calculating a value of a CSI report priority, in equation (1), when a CSI report carries L1-RSRP/L1-SINR or a report quantity related to an AI model, k=0.

In some other embodiments, a new report quantity may further be categorized as a second category. That is, when calculating a value of a CSI report priority, in equation (1), when a CSI report carries non-L1-RSRP/L1-SINR or a report quantity related to an AI model, k=1.

For a report quantity related to an AI model, when calculating a value of a CSI report priority, a report quantity related to model inference may also be categorized as a first category, i.e., in equation (1), when a CSI report carries L1-RSRP/L1-SINR or a report quantity related to AI model inference, k=0; and a report quantity related to model performance monitoring is categorized as a first category, i.e., in equation (1), when a CSI report carries non-L1-RSRP/L1-SINR or a report quantity related to AI model performance monitoring, k=1, vice versa.

In some embodiments, when a scheduling algorithm of a network device is unable to avoid a CSI report related to an AI model (i.e., a first CSI report) and a CSI report not related to an AI model (i.e., a second CSI report) from being transmitted simultaneously, and the network device does not expect that a CSI report related to an AI model or a CSI report not related to an AI model is omitted, the network device may configure parameters such that a CSI report related to an AI model and a CSI report not related to an AI model have different priorities, that is, a terminal equipment expects the network device to configure parameters with different priorities for a CSI report related to an AI model and a CSI report not related to an AI model. That is, a terminal equipment expects that a value of a CSI report priority related to an AI model is less than a value of a CSI report priority not related to an AI model; or, a value of a CSI report priority related to an AI model is greater than a value of a CSI report priority not related to an AI model.

For example, a terminal equipment simultaneously transmits a CSI report carrying L1-SINR of a current serving cell and a CSI report carrying a report quantity related to an AI model (assuming that a parameter representing a CSI report configuration type in the two CSI reports are the same and a parameter representing a serving cell index in the two CSI reports are the same), at this point, if that calculation of a CSI report priority corresponds to a case where k=0 in equation (1) includes that a CSI report carries L1-RSRP/L1-SINR or a report quantity related to an AI model, a network device does not expect that a CSI report carrying L1-SINR of a current serving cell is omitted, the network device may configure a larger CSI report configuration identifier (e.g., a parameter representing a CSI report configuration identifier) for a CSI report related to an AI model (compared to a CSI report carrying L1-SINR of a current serving cell), or the terminal equipment expects the network device to configure a larger CSI report configuration identifier (e.g., a parameter representing a CSI report configuration identifier) for a CSI report related to an AI model, at this point, a priority value of a CSI report related to an AI model, calculated by a terminal, will be greater than a priority value of a CSI report carrying L1-SINR of a current serving cell, then a CSI report related to an AI model may be preferentially omitted, vice versa.

For another example, in an inference phase of an AI model, reported L1-RSRP/L1-SINR is obtained through prediction. Compared to actually measured L1-RSRP/L1-SINR, there is a problem of prediction accuracy. Therefore, a CSI report related to model inference may be configured with a lower priority, and a network may configure a larger CSI report configuration identifier (e.g., a parameter representing a CSI report configuration identifier) for a CSI report related to model inference.

For a further example, when AI model performance monitoring is performed, a performance metric value thereof will be used for association with model lifecycle. A network device does not expect to omit a CSI report related to AI model performance monitoring. At this point, the network device may configure a smaller CSI report configuration identifier (e.g., a parameter representing a CSI report configuration identifier is smaller) for a CSI report related to model performance monitoring, such that the CSI report related to model performance monitoring has a higher priority.

In addition, the above mode for configuring a CSI report configuration identifiers may also be applied to a serving cell index and/or a CSI report configuration type. For example, for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, values of parameters representing a channel state information (CSI) report quantity are the same (for example, are equal to a first value or a second value), and channel state information (CSI) report configuration identifiers and/or serving cell indices and/or CSI report configuration types configured by a network device are not the same.

### Embodiment 3

When performing spatial-domain or time-domain prediction on an analog beam (or pair) via a terminal-side AI model, for a CSI report related to an AI model (i.e., a first CSI report) and a CSI report not related to an AI model (i.e., a second CSI report), values of priorities of these CSI reports may be calculated according to at least one of the following parameters:
a parameter s representing a channel state information (CSI) report configuration identifier;
a parameter c representing a serving cell index;
a parameter k representing a channel state information report quantity (CSI report quantity); or
a parameter y representing a channel state information report configuration type (CSI report configuration type).

In Embodiment 3, a value of k may be extended according to equation (1) to set different values of k for a CSI report related to an AI model and a CSI report not related to an AI model. For example, the following equation (2) may be used to calculate a value Pri_{CSI} of a priority of a CSI report.

Pri_{CSI}(y,k,c,s)=Mₖ·N_{cells}·Mₛ·y+N_{cells}·Mₛ·k+Mₛ·C+S (2)

k is a parameter representing a CSI report quantity, and Mₖ−1 represents a maximum value of k. For a CSI report not related to an AI model and carrying L1-RSRP or Signal to Interference plus Noise Ratio (L1-SINR), k=0; for a CSI report not related to an AI model and not carrying L1-RSRP or L1-SINR, k=1; for a CSI report carrying a report quantity related to AI model inference, k=2; and for a CSI report carrying a report quantity related to AI model performance monitoring, k=3, moreover, k may also take other values different from 0 and 1; here Mₖ=4. In addition, for a CSI report carrying a report quantity related to AI model performance monitoring and a CSI report carrying a report quantity related to AI model inference, k may also take other values, and a corresponding value of Mₖ will change accordingly. The present disclosure is not limited thereto.

Moreover, for a CSI report carrying a report quantity related to an AI model and a CSI report carrying a report quantity not related to an AI model, the present disclosure does not impose limitations on which kind of report quantity corresponds to a value of k. Correspondence between a report quantity and a value of k may be set as needed.

For example, if it is desired that a CSI report carrying a report quantity related to AI model performance monitoring is not omitted, in a case where a value of Mₖ is fixed, for a report quantity related to AI model performance monitoring, a value of k may be smaller, e.g., k=0. In this way, a value of a CSI report priority carrying a report quantity related to AI model performance monitoring is smaller, and a priority is higher.

In the above implementations of Embodiment 3, for report quantities related to an AI model, i.e., report quantities related to model inference and related to model performance monitoring, correspond to different k values.

In addition, the present disclosure is not limited thereto, report quantities related to an AI model may further correspond to one k value, e.g., k=2, at this point, Mₖ=3. In this case, in order to further distinguish priorities of different report quantities related to an AI model, it may be achieved via a CSI report configuration identifier and/or a serving cell index and/or a CSI report configuration type configured by a network device. For example, if the network device does not expect that a CSI report related to AI model performance monitoring is omitted, when configuring CSI report parameters for model performance monitoring and model inference, the network device configures a smaller CSI report configuration identifier (e.g., a parameter representing a CSI report configuration identifier is smaller) for a CSI report related to performance monitoring, and configures a larger CSI report configuration identifier (e.g., a parameter representing a CSI report configuration identifier is larger) for a CSI report related to model inference.

Moreover, for description of other parameters in equation (2), see relevant descriptions for equation (1).

### Embodiment 4

When performing spatial-domain or time-domain prediction on an analog beam (or pair) via a terminal-side AI model, for a CSI report related to an AI model (i.e., a first CSI report) and a CSI report not related to an AI model (i.e., a second CSI report), values of priorities of these CSI reports may be calculated according to at least one of the following parameters:
a parameter s representing a channel state information (CSI) report configuration identifier;
a parameter c representing a serving cell index;
a parameter k representing a channel state information report quantity (CSI report quantity);
a parameter y representing a channel state information report configuration type (CSI report configuration type); or
a parameter x representing whether a channel state information report is related to an AI model.

For a parameter x representing whether a CSI report is related to an AI model, a network device may explicitly provide the parameter x in an information element such as CSI-reportConfig (CSI report configuration). For example, one information field is added to indicate whether the CSI report is related to an AI model, as shown in Table 3.

TABLE 3

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |
| reportwithAImodel | ENUMERATED{supported} | OPTIONAL, |

| | |
|---|---|
| reportConfigType | CHOICE { |

```
    ...
  },
```

| | |
|---|---|
| reportQuantity | CHOICE { |

```
      ...
  },
  ...
}
```

In the example shown in Table 3, an information field reportwithAImodel is added to explicitly indicate whether a configuration of the CSI report is used for a CSI report carrying a report quantity related to an AI model, a data type thereof is of an enumeration type. When configured as ‘supported’, it indicates that a configuration of the CSI report is used for a CSI report carrying a report quantity related to an AI model, and when not configured, a configuration of the CSI report is used for a CSI report carrying a report quantity not related to an AI model. The above field names and data types are only illustrated with examples, and the present disclosure is not limited thereto.

For a parameter x representing whether a CSI report is related to an AI model, a terminal equipment may also implicitly infer and process the parameter x via a configuration of a CSI report quantity configured in the CSI-reportConfig information element. For example, when the CSI report quantity is a report quantity related to AI model inference (e.g., predicted L1-RSRP/L1-SINR or probability information of beam prediction) or a report quantity related to an AI model performance monitoring (e.g., a performance metric value of an AI model), the terminal device assumes that the CSI report is related to an AI model, otherwise, the terminal assumes that the CSI report is not related to an AI model.

In some examples of Embodiment 4, a value Pri_{CSI} of a CSI report priority may be calculated through the following equation (3).

Pri_{CSI}(y,k,c,s)=M_{y}·Mₖ·N_{cells}·Mₛ·x+Mₖ·N_{cells}·Mₛ·y+N_{cells}·Mₛ·k+Mₛ·c+s (3)

x is a parameter representing whether a CSI report is related to an AI model. For example, in a case where a CSI report is not related to an AI model (e.g., in the case of a second CSI report), x=0; and in a case where a CSI report is related to an AI model, x=1. The present disclosure does not impose any limitation on which kind of CSI report corresponds to a value of which kind of x. For example, the above two kinds of CSI reports may also be that: a CSI report related to an AI model corresponds to x=1, and a CSI report not related to an AI model corresponds to x=0. For example, x may also take other values, which are not listed one by one here.

M_{y}−1 represents a maximum value of y. For example, the definition of y is the same as equation (1), M_{y}=4.

k is a parameter representing a CSI report quantity, and Mₖ−1 represents a maximum value of k. For a CSI report not related to an AI model and carrying L1-RSRP or Signal to Interference plus Noise Ratio (L1-SINR), k=0; for a CSI report not related to an AI model and not carrying L1-RSRP or L1-SINR, k=1; for a CSI report carrying a report quantity related to AI model inference, k=0; and for a CSI report carrying a report quantity related to AI model performance monitoring, k=1; here Mₖ=2. The present disclosure does not impose any limitation on which kind of report quantity carried by a CSI report corresponds to a value of k.

Definitions of other parameters in equation (3) are the same as those in equation (1).

In some other examples of Embodiment 4, a value Pri_{CSI} of a CSI report priority may be calculated through the following equation (4).

Pri_{CSI}(y,k,c,s)=Mₓ·Mₖ·N_{cells}·Mₛ·y+Mₖ·N_{cells}·Mₛ·x+N_{cells}·Mₛ·k+Mₛ·c+s (4)

Mₓ−1 represents a maximum value of x. For example, the definition of x is the same as equation (3), Mₓ=2. Definitions of other parameters in equation (4) are the same as those in equation (3).

In some other examples of Embodiment 4, a value Pri_{CSI} of a CSI report priority may be calculated through the following equation (5).

Pri_{CSI}(y,k,c,s)=Mₖ·Mₓ·N_{cells}·Mₛ·y+Mₓ·N_{cells}·Mₛ·k+N_{cells}·Mₛ·x+Mₛ·c+S (5)

In some further examples of Embodiment 4, a value Pri_{CSI} of a CSI report priority may be calculated through the following equation (6).

Pri_{CSI}(y,k,c,s)=Mₖ·N_{cells}·Mₓ·Mₛ·y+N_{cells}·Mₓ·Mₛ·k+Mₓ·Mₛ·c+Mₛ·x+s (6)

In some other examples of Embodiment 4, a value Pri_{CSI} of a CSI report priority may be calculated through the following equation (7).

Pri_{CSI}(y,k,c,s)=Mₖ·N_{cells}·Mₛ·Mₓ·y+N_{cells}·Mₛ·Mₓ·k+Mₛ·Mₓ·c+Mₓ·s+x (7)

Embodiments of the first aspect of the present disclosure are described above with reference to Embodiments 1 to 4. The above Embodiments 1 to 4 do not limit implementation of technical solutions of the present disclosure; for example, the above Embodiments 1 to 4 may be reasonably combined or modified.

According to embodiments of the first aspect of the present disclosure, a terminal equipment receives a parameter of a first channel state information report related to an artificial intelligence model, and calculates a value of a priority of the first channel state information report according to the parameter, thereby being able to set a priority for a CSI report related to an AI model, thus avoiding uncertainty in behaviors of a terminal equipment when reporting a plurality of CSI reports.

### Embodiments of a Second Aspect

Embodiments of a second aspect provide a method for setting a priority of the channel state information report, applicable to a network device, such as the network device 101 in FIG. 1. For parts of embodiments of the second aspect that are the same as those of the first aspect, descriptions in embodiments of the first aspect may be referred to, and details are not repeated here.

FIG. 4 is a schematic diagram of a method for setting a priority of the channel state information report in embodiments of a second aspect. As shown in FIG. 4, the method includes:
operation 401, a network device configures a parameter related to a channel state information (CSI) report for a terminal equipment, and the channel state information report includes a first channel state information report related to an artificial intelligence (AI) model, and the parameter is used to calculate a value of a priority of the channel state information report; and
operation 402, the network device receives a channel state information (CSI) report transmitted by the terminal equipment.

In at least some embodiments, the smaller a value of a priority of the channel state information report is, the higher a priority of a channel state information report is.

In at least some embodiments, the channel state information (CSI) report further includes a second channel state information report that is not related to an artificial intelligence (AI) model, and the network device schedules that the first channel state information report and the second channel state information report are not transmitted simultaneously.

In at least some embodiments, the channel state information (CSI) report further includes a second channel state information report that is not related to an artificial intelligence (AI) model, the network device schedules that the first channel state information report and the second channel state information report are transmitted simultaneously, the network device configures that a value of the priority of the first channel state information report is greater than a value of the priority of the second channel state information report, or, the network device configures that a value of the priority of the second channel state information report is greater than a value of the priority of the first channel state information report.

In at least some embodiments, a network device schedules that the first channel state information report carrying a report quantity related to model inference and the first channel state information report carrying a report quantity related to model performance monitoring are not transmitted simultaneously.

In some embodiments of operation 401, the parameter for calculating a value of the priority of the channel state information report may include at least one of the following parameters:
a parameter representing a channel state information (CSI) report configuration identifier;
a parameter representing a serving cell index;
a parameter representing a channel state information report quantity (CSI report quantity);
a parameter representing a channel state information report configuration type (CSI report configuration type); or
a parameter representing whether a channel state information report is related to an artificial intelligence (AI) model.

The CSI report quantity is related to an artificial intelligence (AI) model. For example, the CSI report quantity includes predicted Layer 1 Reference Signal Receiving Power (L1-RSRP) or Layer 1 Signal to Interference plus Noise Ratio (L1-SINR), probability information of beam prediction, or a performance metric of a model, wherein the predicted Layer 1 reference signal receiving power or the Layer 1 signal to interference plus noise ratio, or the probability information of beam prediction is obtained by the terminal equipment through inferring of an artificial intelligence (AI) model, and a performance metric value of the model is obtained by the terminal equipment through performance monitoring of an artificial intelligence model (AI).

The parameter representing whether a channel state information report is related to an artificial intelligence (AI) model is used to indicate whether the channel state information report contains a channel state information (CSI) report quantity related to an artificial intelligence (AI) model.

In some embodiments, for calculation of a value of the priority of the first channel state information report, a value of a parameter representing a channel state information report quantity is a first value or a second value; or, for calculation of a value of the priority of the first channel state information report carrying a report quantity related to artificial intelligence (AI) model inference, a value of a parameter representing a channel state information report quantity is one of a first value and a second value, and for calculation of a value of the priority of the first channel state information report carrying a report quantity related to artificial intelligence (AI) model performance monitoring, a value of a parameter representing a channel state information report quantity is the other of a first value and a second value; or, for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, values of parameters representing a channel state information (CSI) report quantity are a first value or a second value, and a channel state information (CSI) report configuration identifier and/or a serving cell index and/or a CSI report configuration type configured by the network device is/are not the same.

In some embodiments, for calculation of a value of the priority of the first channel state information report, a value of a parameter representing a channel state information report quantity is different from a first value and a second value, and for calculation of a value of a priority of the second channel state information report that is not related to an artificial intelligence (AI) model, a value of a parameter representing a channel state information report quantity is the first value or the second value.

For calculation of a value of the priority of the first channel state information report carrying a report quantity related to artificial intelligence (AI) model inference, the value of the parameter representing a channel state information report quantity is a third value, and for calculation of a value of the priority of the first channel state information report carrying a report quantity related to artificial intelligence (AI) model performance monitoring, the value of the parameter representing a channel state information report quantity is a fourth value. The third value and the fourth value are equal or unequal.

In some examples, a third value is equal to a fourth value, and for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, a channel state information (CSI) report configuration identifier and/or a serving cell index and/or a channel state information report configuration type configured by the network device is/are not the same.

### Embodiments of a Third Aspect

At least for the same problem as that in embodiments of the first aspect, embodiments of a third aspect of the present disclosure provide an apparatus for setting a priority of the channel state information report, applicable to a terminal equipment and corresponding to embodiments of the first aspect.

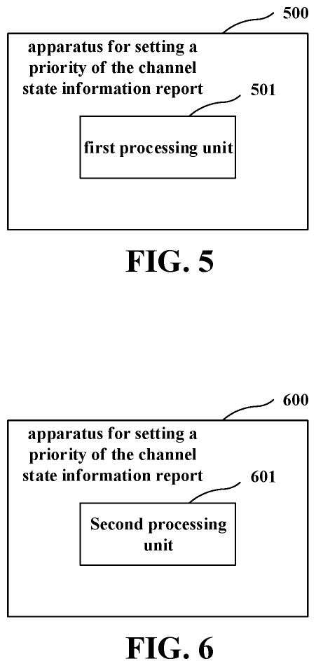

FIG. 5 is a schematic diagram of an apparatus for setting a priority of the channel state information report in embodiments of a third aspect. As shown in FIG. 5, an apparatus 500 for setting a priority of the channel state information report includes a first processing unit 501.

The first processing unit 501 enables the terminal equipment to perform the following operations:
receiving a parameter related to a channel state information report (CSI), configured by a network device, and the channel state information report includes a first channel state information report related to an artificial intelligence (AI) model; and
calculating a value of the priority of the channel state information report according to the parameter, and determining a priority of the channel state information (CSI) report.

In some embodiments, the smaller a value of the priority of the channel state information report is, the higher a priority of the channel state information report is.

In some embodiments, the terminal equipment further performs the following operation:

the terminal equipment prioritizes transmission of a channel state information (CSI) report with a higher priority.

In some embodiments, the channel state information (CSI) report further includes a second channel state information report that is not related to an artificial intelligence (AI) model, and the terminal equipment expects that the first channel state information report and the second channel state information report are not transmitted simultaneously; and/or
the terminal equipment expects that the first channel state information report carrying a report quantity related to model inference and the first channel state information report carrying a report quantity related to model performance monitoring are not transmitted simultaneously.

In some embodiments, the channel state information (CSI) report further includes a second channel state information report that is not related to an artificial intelligence (AI) model, in a case where the first channel state information report and the second channel state information report are transmitted simultaneously, the terminal equipment expects that a value of the priority of the first channel state information report is greater than a value of the priority of the second channel state information report, or the terminal equipment expects that a value of the priority of the second channel state information report is greater than a value of the priority of the first channel state information report.

In some embodiments, the parameter for calculating a value of the priority of the channel state information report may include at least one of the following parameters:
a parameter representing a channel state information (CSI) report configuration identifier;
a parameter representing a serving cell index;
a parameter representing a channel state information report quantity (CSI report quantity);
a parameter representing a channel state information report configuration type (CSI report configuration type); or
a parameter representing whether a channel state information report is related to an artificial intelligence (AI) model.

In some embodiments, the channel state information report (CSI report) quantity related to an artificial intelligence (AI) model, wherein the CSI report quantity includes predicted Layer 1 reference signal receiving power (L1-RSRP) or Layer 1 signal to interference plus noise ratio (L1-SINR), probability information of beam prediction, or performance metrics of a model;
the predicted Layer 1 reference signal receiving power or the Layer 1 signal to interference plus noise ratio, or the probability information of beam prediction is obtained by the terminal equipment through inferring of an artificial intelligence (AI) model, and a performance metric value of the model is obtained by the terminal equipment through performance monitoring of an artificial intelligence model (AI).

In some embodiments, the parameter representing whether a channel state information report is related to an artificial intelligence (AI) model is used to indicate whether the channel state information report contains a channel state information (CSI) report quantity related to an artificial intelligence (AI) model.

In some embodiments, for calculation of a value of the priority of the first channel state information report, a value of the parameter representing a channel state information report quantity is a first value or a second value; or
for calculation of a value of the priority of the first channel state information report carrying a report quantity related to artificial intelligence (AI) model inference, a value of the parameter representing a channel state information report quantity is one of a first value and a second value, and for calculation of a value of the priority of the first channel state information report carrying a report quantity related to artificial intelligence (AI) model performance monitoring, a value of the parameter representing a channel state information report quantity is the other of a first value and a second value; or
for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, values of the parameters representing a channel state information (CSI) report quantity are a first value or a second value, and the terminal equipment expects that a channel state information (CSI) report configuration identifier and/or a serving cell index and/or a channel state information report configuration type configured by a network device is/are not the same.

In some embodiments, for calculation of a value of the priority of the first channel state information report, a value of a parameter representing a channel state information report quantity is different from a first value and a second value, wherein for calculation of a value of a priority of the second channel state information report that is not related to an artificial intelligence (AI) model, a value of a parameter representing a channel state information report quantity is the first value or the second value.

In some embodiments, for calculation of a value of the priority of the first channel state information report carrying a report quantity related to artificial intelligence (AI) model inference, a value of the parameter representing a channel state information report quantity is a third value; and
for calculation of a value of the priority of the first channel state information report carrying a report quantity related to artificial intelligence (AI) model performance monitoring, a value of the parameter representing a channel state information report quantity is a fourth value, the third value being equal to or unequal to the fourth value.

In some embodiments, the third value is equal to the fourth value, and for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, a terminal equipment expects that a channel state information (CSI) report configuration identifier and/or a serving cell index and/or a channel state information report configuration type configured by a network device is/are not the same.

In some embodiments, a value of the priority of the channel state information report is calculated according to a parameter x representing whether a channel state information report is related to an artificial intelligence (AI) model.

In some embodiments, for calculation of a value of the priority of the first channel state information report, a value of the parameter x representing whether a channel state information report is related to an artificial intelligence (AI) model is one of a fifth value and a sixth value; for calculation of a value of a priority of the second channel state information report that is not related to an artificial intelligence (AI) model, a value of the parameter x representing whether a channel state information report is related to an artificial intelligence model is the other of the fifth value and the sixth value.

In some embodiments, a weight of at least one of a parameter s representing a channel state information (CSI) report configuration identifier, a parameter c representing a serving cell index, a parameter k representing a channel state information (CSI) report quantity or a parameter y representing a channel state information (CSI) report configuration type is adjusted by using a parameter x representing whether a channel state information report is related to an artificial intelligence model (AI), so as to calculate a value of the priority of the channel state information report.

### Embodiments of a Fourth Aspect

Embodiments of a fourth aspect of the present disclosure provide an apparatus for setting a priority of the channel state information report, applicable to a network device and corresponding to the method in embodiments of the second aspect.

FIG. 6 is a schematic diagram of an apparatus for setting a priority of the channel state information report in embodiments of a fourth aspect. As shown in FIG. 6, the apparatus 600 for setting a priority of the channel state information report includes a second processing unit 601.

In at least one embodiment, the second processing unit 601 controls the network device to perform the following operation:
the network device configures a channel state information (CSI) report related parameter for a terminal equipment, wherein the channel state information report includes a first channel state information report related to an artificial intelligence (AI) model, and the parameter is used to calculate a value of a priority of the channel state information report; and
receives a channel state information (CSI) report transmitted by the terminal equipment.

In at least some embodiments, the smaller a value of the priority of the channel state information report is, the higher a priority of the channel state information report is.

In at least some embodiments, the channel state information (CSI) report further includes a second channel state information report that is not related to an artificial intelligence (AI) model, and the network device schedules that the first channel state information report and the second channel state information report are not transmitted simultaneously; and/or
the network device schedules that the first channel state information report carrying a report quantity related to model inference and the first channel state information report carrying a report quantity related to model performance monitoring are not transmitted simultaneously.

In at least some embodiments, the channel state information (CSI) report further includes a second channel state information report that is not related to an artificial intelligence (AI) model, and the network device schedules that the first channel state information report and the second channel state information report are transmitted simultaneously; and
the network device configures that a value of the priority of the first channel state information report is greater than a value of the priority of the second channel state information report, or, the network device configures that a value of the priority of the second channel state information report is greater than a value of the priority of the first channel state information report.

In at least some embodiments, the parameter for calculating a value of the priority of the channel state information report may include at least one of the following parameters:
a parameter representing a channel state information (CSI) report configuration identifier;
a parameter representing a serving cell index;
a parameter representing a channel state information report quantity (CSI report quantity);
a parameter representing a channel state information report configuration type (CSI report configuration type); or
a parameter representing whether a channel state information report is related to an artificial intelligence (AI) model.

In at least some embodiments, the channel state information report (CSI report) quantity related to an artificial intelligence (AI) model, wherein the CSI report quantity includes predicted Layer 1 reference signal receiving power (L1-RSRP) or Layer 1 signal to interference plus noise ratio (L1-SINR), probability information of beam prediction, or performance metrics of a model;
the predicted Layer 1 reference signal receiving power or the Layer 1 signal to interference plus noise ratio, or the probability information of beam prediction is obtained by the terminal equipment through inferring of an artificial intelligence (AI) model, and a performance metric value of the model is obtained by the terminal equipment through performance monitoring of an artificial intelligence model (AI).

In at least some embodiments, the parameter representing whether a channel state information report is related to an artificial intelligence (AI) model is used to indicate whether the channel state information report contains a channel state information (CSI) report quantity related to an artificial intelligence (AI) model.

In at least some embodiments, for calculation of a value of the priority of the first channel state information report, a value of the parameter representing a channel state information report quantity is a first value or a second value; or
for calculation of a value of the priority of the first channel state information report carrying a report quantity related to artificial intelligence (AI) model inference, a value of the parameter representing a channel state information report quantity is one of a first value and a second value, and for calculation of a value of the priority of the first channel state information report carrying a report quantity related to artificial intelligence (AI) model performance monitoring, a value of the parameter representing a channel state information report quantity is the other of a first value and a second value; or
for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, values of the parameters representing a channel state information (CSI) report quantity are a first value or a second value, and channel state information (CSI) report configuration identifiers and/or a serving cell indices and/or channel state information report configuration types configured by the network device are not the same.

In at least some embodiments, for calculation of a value of the priority of the first channel state information report, a value of a parameter representing a channel state information report quantity is different from a first value and a second value, wherein for calculation of a value of a priority of the second channel state information report that is not related to an artificial intelligence (AI) model, a value of a parameter representing a channel state information report quantity is the first value or the second value.

In at least some embodiments, for calculation of a value of the priority of the first channel state information report carrying a report quantity related to artificial intelligence (AI) model inference, a value of the parameter representing a channel state information report quantity is a third value; and
for calculation of a value of the priority of the first channel state information report carrying a report quantity related to artificial intelligence (AI) model performance monitoring, a value of the parameter representing a channel state information report quantity is a fourth value, the third value being equal to or unequal to the fourth value.

In at least some embodiments, the third value is equal to the fourth value, and for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, channel state information (CSI) report configuration identifiers and/or serving cell indices and/or channel state information report configuration types configured by the network device are not the same.

### Embodiments of a Fifth Aspect

Embodiments of a fifth aspect of the present disclosure provide a communication system, the communication system may include a network device and a terminal equipment.

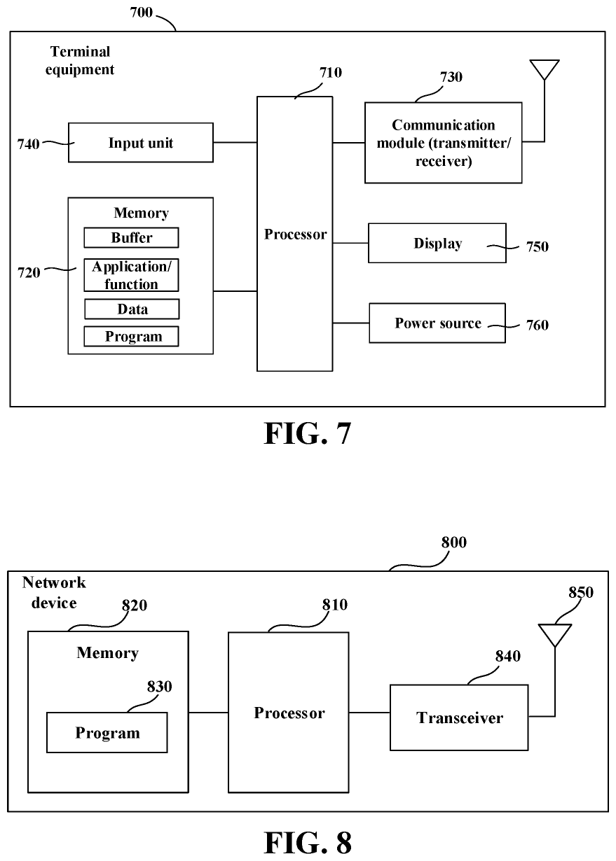

FIG. 7 is a schematic diagram of a terminal equipment in embodiments of a fifth aspect. As shown in FIG. 7, the terminal equipment 700 (for example, corresponding to the terminal equipment 102 in FIG. 1) may include a processor 710, and a memory 720 configured to store data and programs and be coupled to the processor 710. It is worth noting that this figure is exemplary, other types of structures may also be used to supplement or replace this structure, to implement a telecommunication function or other functions.

For example, processor 710 may be configured to execute a program to implement the method in embodiments of the first aspect.

As shown in FIG. 7, the terminal equipment 700 may further include: a communication module 730, an input unit 740, a display 750, and a power supply 760. Functions of the above components are similar to related arts, and are not further elaborated here. It is worth noting that the terminal equipment 700 does not have to include all components shown in FIG. 7, said components are not indispensable. Moreover, the terminal equipment 700 may further include components not shown in FIG. 7, related arts may be referred to.

FIG. 8 is a schematic diagram of a network device in embodiments of a fifth aspect. As shown in FIG. 8, the network device 800 (for example, corresponding to the network device 101 in FIG. 1) may include: a processor 810 (such as a central processing unit (CPU)), and a memory 820 configured to be coupled to the processor 810. The memory 820 may store various data; moreover, further stores a program 830 for information processing, and executes the program 830 under the control of the processor 810.

For example, the processor 810 may be configured to execute a program to implement a method in embodiments of the second aspect.

In addition, as shown in FIG. 8, the network device 800 may further include a transceiver 840 and an antenna 850, etc., wherein functions of said components are similar to related arts and are not further elaborated here. It is worth noting that the network device 800 does not have to include all components shown in FIG. 8. Moreover, the network device 800 may further include components not shown in FIG. 8, related arts may be referred to.

Embodiments of the present disclosure further provide a computer program, wherein when a terminal equipment executes the program, the program enables the terminal equipment to execute the method described in embodiments of the first aspect.

Embodiments of the present disclosure further provide a storage medium in which a computer program is stored, wherein the computer program enables a terminal equipment to execute the method described in embodiments of the first aspect.

Embodiments of the present disclosure further provide a computer program, wherein when a network device executes the program, the program enables the network device to execute the method described in embodiments of the second aspect.

Embodiments of the present disclosure further provide a storage medium in which a computer program is stored, wherein the computer program enables a network device to execute the method described in embodiments of the second aspect.

Apparatuses and methods in the present disclosure may be implemented by hardware, or may be implemented by combining hardware with software. The present disclosure relates to such a computer readable program that when the program is executed by a logic component, the logic component is able to implement apparatuses described in the above text or a constituent component, or the logic component is able to implement various methods or steps described in the above text. The present disclosure further relates to a storage medium storing the above programs, such as a hard disk, a magnetic disk, an optical disk, a DVD, a flash memory and the like.

Methods/apparatuses described by combining with embodiments of the present disclosure may be directly embodied as hardware, a software module executed by a processor, or a combination of the two. For example, one or more of functional block diagrams shown in drawings or one or more combinations of functional block diagrams may correspond to software modules of a computer program process, or may correspond to hardware modules. These software modules may respectively correspond to steps shown in drawings. These hardware modules may be implemented by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM, or any other form of storage medium known in the art. A storage medium may be coupled to a processor, thus enabling the processor to read information from the storage medium and write information into the storage medium, or the storage medium may be a constituent part of a processor. A processor and a storage medium may be located in an ASIC. The software module may be stored in a memory of a mobile terminal, or may be stored in a memory card that may be inserted into a mobile terminal. For example, if a device (e.g., a mobile terminal) adopts a MEGA-SIM card with a larger capacity or a flash memory apparatus with a large capacity, the software module may be stored in the MEGA-SIM card, or in the flash memory apparatus with a large capacity.

One or more of functional block diagrams described in drawings or one or more combinations of functional block diagrams may be implemented as a general-purpose processor for performing functions described in the present disclosure, a digital signal processor (DSP), an application-specific integrated circuit (ASIC), a field-programmable gate array (FPGA) or other programmable logic device, a discrete gate or a transistor logic device, a discrete hardware component, or any appropriate combination thereof. One or more of functional block diagrams described in drawings or one or more combinations of functional block diagrams may further be implemented as a combination of computing devices, such as a combination of a DSP and a microprocessor, a plurality of microprocessors, one or more microprocessors combined and communicating with a DSP, or any other such configuration.

The present disclosure is described above by combining with specific implementations, however persons skilled in the art should clearly know that these descriptions are exemplary and do not limit protection scopes of the present disclosure. Persons skilled in the art may make various variations and amendments to the present disclosure according to spirits and principles of the present disclosure, these variations and amendments are also within scopes of the present disclosure.

As for implementations including the above embodiments, the following supplements are further disclosed:
1. A method for setting a priority of a channel state information report, applicable to a network device, wherein the method includes that:
configuring a channel state information (CSI) report related parameter for a terminal equipment by the network device, wherein the channel state information report includes a first channel state information report related to an artificial intelligence (AI) model, and the parameter is used to calculate a value of a priority of a channel state information report; and
receiving a channel state information (CSI) report transmitted by the terminal equipment.
2. The method according to supplement 1, wherein,
the channel state information (CSI) report further includes a second channel state information report that is not related to an artificial intelligence (AI) model, and the network device schedules the first channel state information report and the second channel state information report not to be transmitted simultaneously; and/or
the network device schedules the first channel state information report carrying a report quantity related to model inference and the first channel state information report carrying a report quantity related to model performance monitoring not to be transmitted simultaneously.
3. The method according to supplement 1, wherein,
the channel state information (CSI) report further includes a second channel state information report that is not related to an artificial intelligence (AI) model,
the network device schedules the first channel state information report and the second channel state information report to be transmitted simultaneously, and
the network device configures that a value of a priority of the first channel state information report is greater than a value of a priority of the second channel state information report, or, the network device configures that a value of a priority of the second channel state information report is greater than a value of a priority of the first channel state information report.
4. The method according to supplement 1, wherein,
the parameter for calculating a value of a priority of the channel state information report includes at least one of the following:
a parameter representing a channel state information (CSI) report configuration identifier;
a parameter representing a serving cell index;
a parameter representing a channel state information report quantity (CSI report quantity);
a parameter representing a channel state information report configuration type (CSI report configuration type); or
a parameter representing whether a channel state information report is related to an artificial intelligence (AI) model.
5. The method according to supplement 4, wherein,
the channel state information report quantity (CSI report quantity) is related to an artificial intelligence (AI) model,
wherein the channel state information report quantity (CSI report quantity) includes predicted Layer 1 reference signal receiving power (L1-RSRP) or Layer 1 signal to interference plus noise ratio (L1-SINR), probability information of beam prediction, or performance metrics of a model,
wherein the predicted Layer 1 reference signal receiving power or the Layer 1 signal to interference plus noise ratio, or the probability information of beam prediction is obtained by the terminal equipment through inferring of an artificial intelligence (AI) model, and a performance metric value of the model is obtained by the terminal equipment through performance monitoring of an artificial intelligence model (AI).
6. The method according to supplement 4, wherein,
the parameter representing whether a channel state information report is related to an artificial intelligence (AI) model is used to indicate whether the channel state information report contains a channel state information (CSI) report quantity related to an artificial intelligence (AI) model.
7. The method according to supplement 4, wherein,
for calculation of a value of a priority of the first channel state information report, a value of the parameter representing a channel state information report quantity is a first value or a second value; or
for calculation of a value of a priority of the first channel state information report carrying a report quantity related to artificial intelligence (AI) model inference, a value of the parameter representing a channel state information report quantity is one of a first value and a second value, and for calculation of a value of the priority of the first channel state information report carrying a report quantity related to artificial intelligence (AI) model performance monitoring, a value of the parameter representing a channel state information report quantity is the other of the first value and the second value; or
for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, values of the parameters representing a channel state information (CSI) report quantity are a first value or a second value, and channel state information (CSI) report configuration identifiers and/or serving cell indices and/or channel state information report configuration types configured by the network device are not the same.
8. The method according to supplement 4, wherein,
for calculation of a value of a priority of the first channel state information report, a value of the parameter representing a channel state information report quantity is different from a first value and a second value,
wherein for calculation of a value of a priority of the second channel state information report that is not related to an artificial intelligence (AI) model, a value of the parameter representing a channel state information report quantity is the first value or the second value.
9. The method according to supplement 8, wherein,
for calculation of a value of a priority of the first channel state information report carrying a report quantity related to artificial intelligence (AI) model inference, a value of the parameter representing a channel state information report quantity is a third value; and
for calculation of a value of a priority of the first channel state information report carrying a report quantity related to artificial intelligence (AI) model performance monitoring, a value of the parameter representing a channel state information report quantity is a fourth value, the third value being equal to or unequal to the fourth value.
10. The method according to supplement 9, wherein,
the third value is equal to the fourth value, and,
for calculation of a value of the priority of the first channel state information report carrying a report quantity related to artificial intelligence (AI) model inference, and for calculation of a value of the priority of the first channel state information report carrying a report quantity related to artificial intelligence (AI) model performance monitoring, channel state information (CSI) report configuration identifiers and/or serving cell indices and/or channel state information report configuration types configured by the network device are not the same.

What is claimed is:

1. An apparatus for setting a priority of a channel state information report, applied to a terminal equipment, the apparatus comprising:
a receiver configured to receive configuration information of a channel state information report from a network device, wherein the configuration information comprises configuration of report quantity of channel state prediction for a first channel state information report; and
first processor circuitry configured to calculate a value of a priority of the channel state information report according to the configuration information, and determine a priority of the channel state information report.

2. The apparatus according to claim 1, wherein,
the smaller the value of the priority of the channel state information report is, the higher the priority of the channel state information report is.

3. The apparatus according to claim 1, wherein,
parameter for calculating a value of the priority of the channel state information report comprises at least one of the following:
a parameter representing a channel state information report configuration identifier;
a parameter representing a serving cell index;
a parameter representing a channel state information report quantity; or
a parameter representing a channel state information report configuration type.

4. The apparatus according to claim 1, wherein,
the report quantity of channel state prediction comprises at least one of predicted Layer 1 reference signal receiving power (L1-RSRP), predicted reference signal resource indicator or accuracy of reference signal prediction.

5. The apparatus according to claim 4, wherein,
the predicted reference signal resource indicator comprises channel state information reference signal resource indicator (CRI) or synchronization signal block resource indicator (SSB-RI).

6. The apparatus according to claim 1, wherein,
for calculation of a value of the priority of the first channel state information report, the channel state information report carries at least one of predicted Layer 1 reference signal receiving power (L1-RSRP), predicted reference signal resource indicator or accuracy of reference signal prediction, value of a parameter representing a channel state information report quantity is a first value.

7. The apparatus according to claim 1, wherein,
the configuration information further comprises configuration of report quantity not related to channel state prediction for a second channel state information report,
wherein for calculation of a value of a priority of a second channel state information report, channel state information report doesn't carry any one of predicted Layer 1 reference signal receiving power (L1-RSRP), predicted reference signal resource indicator or accuracy of reference signal prediction, a value of the parameter representing a channel state information report quantity is a second value.

8. An apparatus for setting a priority of a channel state information report, applied to a network device, the apparatus comprising:
a transmitter configured to transmit configuration information related to a channel state information report to a terminal equipment, wherein the configuration information comprises configuration of report quantity of channel state prediction for a first channel state information report, the configuration is used to calculate a value of a priority of the channel state information report by the terminal equipment; and
a receiver configured to receive the channel state information report transmitted by the terminal equipment.

9. The apparatus according to claim 8, wherein,
the smaller the value of the priority of the channel state information report is, the higher the priority of the channel state information report is.

10. The apparatus according to claim 8, wherein,
parameter for calculating a value of the priority of the channel state information report comprises at least one of the following:
a parameter representing a channel state information report configuration identifier;
a parameter representing a serving cell index;
a parameter representing a channel state information report quantity; or
a parameter representing a channel state information report configuration type.

11. The apparatus according to claim 8 wherein,
the report quantity of channel state prediction comprises at least one of predicted Layer 1 reference signal receiving power (L1-RSRP), predicted reference signal resource indicator or accuracy of reference signal prediction.

12. The apparatus according to claim 11, wherein,
the predicted reference signal resource indicator comprises channel state information reference signal resource indicator (CRI) or synchronization signal block resource indicator (SSB-RI).

13. The apparatus according to claim 8, wherein,
for calculation of a value of a priority of the first channel state information report, the channel state information report carries at least one of predicted Layer 1 reference signal receiving power (L1-RSRP), predicted reference signal resource indicator or accuracy of reference signal prediction, a value of the parameter representing a channel state information report quantity is a first value.

14. The apparatus according to claim 8, wherein,
the configuration information further comprises configuration of a report quantity not related to channel state prediction for a second channel state information report,
wherein for calculation of a value of a priority of the second channel state information report, the channel state information report doesn't carry any one of predicted Layer 1 reference signal receiving power (L1-RSRP), predicted reference signal resource indicator or accuracy of reference signal prediction, a value of the parameter representing a channel state information report quantity is a second value.
